(19) United States
(12) Patent Application Publication
(10) Pub. No.: US 2026/0110342 A1
(43) Pub. Date: Apr. 23, 2026

(54) POWER TRANSMISSION DEVICE

(71) Applicant: NSK-WARNER K.K., Tokyo (JP)

(72) Inventors: Nariaki TAMURA, Shizuoka (JP); Masato Kobayashi, Shizuoka (JP); Yukiyoshi Suzuki, Shizuoka (JP); Tomoyuki Kirino, Shizuoka (JP); Kazuyuki Fujita, Shizuoka (JP)

(73) Assignee: NSK-WARNER K.K., Tokyo (JP)

(21) Appl. No.: 19/351,912

(22) Filed: Oct. 7, 2025

(30) Foreign Application Priority Data
Oct. 17, 2024 (JP) 2024-182108

(51) Int. Cl. F16D 41/064

(52) U.S. Cl. CPC F16D 41/064; F16D 2041/0643

(57) ABSTRACT

According to an aspect, a power transmission device includes: an annular fixed part including an inner peripheral surface; an output shaft including an outer peripheral surface facing the inner peripheral surface and a recessed surface recessed radially inward from the outer peripheral surface; an input shaft including a pressing portion accommodated in the recessed surface; a pair of first rolling elements that are accommodated in the recessed surface and are arranged on opposite sides in a circumferential direction with respect to the pressing portion; and a pair of second rolling elements each of which has a smaller diameter than a diameter of each first rolling element and is arranged between the corresponding first rolling element and the pressing portion.

### CROSS-REFERENCE TO RELATED APPLICATION

The present application claims priority to and incorporates by reference the entire contents of Japanese Patent Application No. 2024-182108 filed in Japan on Oct. 17, 2024.

### BACKGROUND

### 1. Technical Field

The present disclosure relates to a power transmission device.

### 2. Description of the Related Art

Power transmission devices transmit torque generated by a motor or the like. Such a power transmission device is used, for example, to drive an arm or the like of an industrial robot. A power transmission device includes an input shaft to which torque is input and an output shaft that outputs torque. An object to be driven is connected to the output shaft. Therefore, the weight or the like of the object (hereinafter, referred to as an external force) may act on the output shaft. At this point, if the output shaft rotates due to the external force, the position of the object is not maintained. Therefore, in a power transmission device of Japanese U.S. Pat. No. 4,621,156, an output shaft does not rotate even in a case where an external force acts on the output shaft.

Details of the power transmission device of Japanese U.S. Pat. No. 4,621,156 will be described. The power transmission device of Japanese U.S. Pat. No. 4,621,156 includes an annular fixed part, an output shaft on which a cam surface facing an inner peripheral surface of the fixed part is formed, a cylindrical roller disposed between the fixed part and the cam surface, and an input shaft on which a pressing portion disposed in the circumferential direction of the cylindrical roller is formed. When an external force acts on the output shaft and the output shaft rotates, the cylindrical roller is sandwiched between the fixed part and the cam surface, whereby rotation of the output shaft is restricted. When torque is input to the input shaft, the pressing portion presses the cylindrical roller. As a result, the cylindrical roller sandwiched between the fixed part and the cam surface moves, whereby the locked state is released.

Meanwhile, at the start of input of torque to the input shaft, there are cases where an external force in the same direction as that of the torque acts on the output shaft. In such cases, even when the cylindrical roller sandwiched between the fixed part and the cam surface is pressed by the pressing portion and moves, the cam surface moves in the same direction, whereby the cylindrical roller may be sandwiched again between the fixed part and the cam surface. That is, an unlocked state and the locked state repeatedly alternate, which may cause an input member and an output member to rotate intermittently. Therefore, it is desired to develop a power transmission device in which the phenomenon of the repetition of the unlocked state and the locked state (hereinafter, referred to as a jerking phenomenon) is unlikely to occur. In addition, it is conventionally desired to reduce the torque for unlocking. For the foregoing reasons, there is a need for a power transmission device capable of reducing torque required for unlocking while suppressing occurrence of the jerking phenomenon.

### SUMMARY

According to an aspect of the present disclosure, a power transmission device includes: an annular fixed part including an inner peripheral surface; an output shaft including an outer peripheral surface facing the inner peripheral surface and a recessed surface recessed radially inward from the outer peripheral surface; an input shaft including a pressing portion accommodated in the recessed surface; a pair of first rolling elements that are accommodated in the recessed surface and are arranged on opposite sides in a circumferential direction with respect to the pressing portion; and a pair of second rolling elements each of which has a smaller diameter than a diameter of each first rolling element and is arranged between the corresponding first rolling element and the pressing portion. The recessed surface includes: a bottom surface extending in the circumferential direction and facing the inner peripheral surface in a radial direction; and a pair of pressed surfaces extending radially outward from opposite circumferential ends of the bottom surface. The bottom surface includes: a pair of cam surfaces each having the corresponding first rolling element arranged on a radially outer side; and a pair of guide surfaces each having the corresponding second rolling element arranged on a radially outer side. A distance between each cam surface and the inner peripheral surface gradually increases with proximity to the corresponding pressed surface. A distance between a portion of each cam surface closer to the corresponding guide surface and the inner peripheral surface is smaller than a diameter of each first rolling element. A distance between a portion of each cam surface closer to the corresponding pressed surface and the inner peripheral surface is larger than the diameter of each first rolling element. The second rolling element is sandwiched between the first rolling element, the guide surface, and the pressing portion. The pressing portion pushes the second rolling element between the first rolling element and the guide surface when the pressing portion moves circumferentially outward from a state in which the pressing portion is disposed at a center portion of the recessed surface in the circumferential direction.

### BRIEF DESCRIPTION OF THE DRAWINGS

FIG. 1 is a schematic diagram of a power transmission device of a first embodiment as viewed from the axial direction;

FIG. 2 is a cross-sectional view taken along line II-II in FIG. 1;

FIG. 3 is an enlarged view in which one of recessed surfaces in FIG. 1 is enlarged;

FIG. 4 is an enlarged view in which a part of FIG. 3 is enlarged;

FIG. 5 is a diagram illustrating an operation state of the power transmission device of the first embodiment and, specifically, is a diagram as of the start of input of torque;

FIG. 6 is a diagram illustrating an operation state of the power transmission device of the first embodiment and is, specifically, a diagram as of the time when a locked state is released;

FIG. 7 is a diagram illustrating an operation state of the power transmission device of the first embodiment and is, specifically, a diagram in a state where a first roller is in contact with a pressed surface;

FIG. 8 is a diagram illustrating an operation state of the power transmission device of the first embodiment and is, specifically, a diagram as of the time when the first roller starts to return in the second rotation direction;

FIG. 9 is a diagram as of the time when input of torque to an input shaft (first rotation direction) is started in a state where an external force (first rotation direction) is acting on an output shaft in the power transmission device of the first embodiment;

FIG. 10 is a diagram as of the time when input of torque to the input shaft (first rotation direction) is started in a state where an external force (second rotation direction) is acting on the output shaft in the power transmission device of the first embodiment;

FIG. 11 is an enlarged view in which one of recessed surfaces of a power transmission device of a first modification is enlarged;

FIG. 12 is a diagram illustrating a state in which a pressing portion is pressing a pressed surface via a first roller in the power transmission device of the first modification;

FIG. 13 is an enlarged view in which one of recessed surfaces of a power transmission device of a second modification is enlarged;

FIG. 14 is a diagram illustrating a state in which a pressing portion is pressing a pressed surface via a second roller and a first roller in the power transmission device of the second modification;

FIG. 15 is a partial cross-sectional view in which the vicinity of a pressed surface is enlarged in a power transmission device of a third modification;

FIG. 16 is an enlarged view in which one of recessed surfaces of a power transmission device of a fourth modification is enlarged;

FIG. 17 is a schematic diagram illustrating the configuration of a driving unit of a second embodiment; and

FIG. 18 is a schematic diagram illustrating the configuration of a driving unit of a fifth modification.

### DETAILED DESCRIPTION

Modes for carrying out the present disclosure will be described in detail with reference to the drawings. The present disclosure is not limited by the content described in the following description. In addition, the components described below include those that can be easily conceived of by those skilled in the art and those that are substantially the same. Furthermore, the components described below can be combined as appropriate.

### First Embodiment

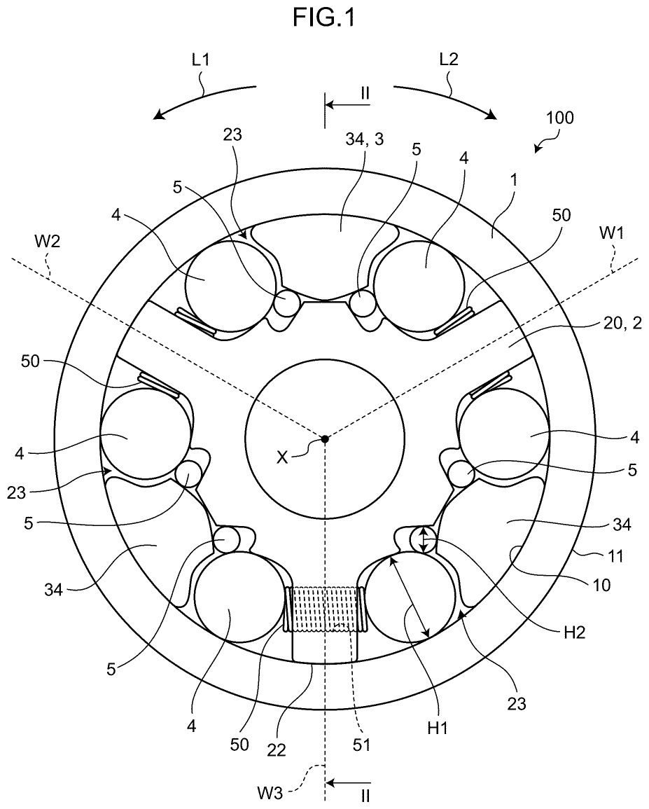

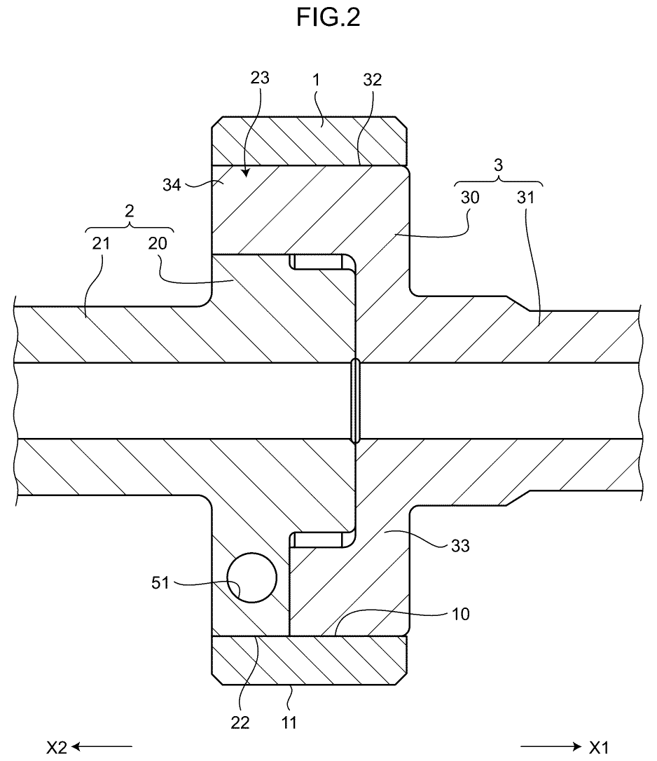

FIG. 1 is a schematic diagram of a power transmission device of a first embodiment as viewed from the axial direction. FIG. 2 is a cross-sectional view taken along line II-II in FIG. 1. As illustrated in FIG. 1, a power transmission device 100 according to the first embodiment includes a fixed part 1, an output shaft 2, an input shaft 3, a plurality of first rollers (first rolling elements) 4, and a plurality of second rollers (second rolling elements) 5.

The fixed part 1 is an annular part. An inner peripheral surface 10 and an outer peripheral surface 11 of the fixed part 1 are formed in a circular shape around the central axis X. Hereinafter, a direction parallel to the central axis X of the inner peripheral surface 10 is referred to as an axial direction. A direction orthogonal to the central axis X is referred to as a radial direction. A direction around the central axis X is referred to as a circumferential direction.

As illustrated in FIG. 2, the output shaft 2 includes an inner ring portion 20 disposed inside the fixed part 1 and an output shaft body 21 protruding to one side in the axial direction from the inner ring portion 20. Meanwhile, the input shaft 3 includes a torque transmission portion 30 disposed inside the fixed part 1 and an input shaft body 31 protruding from the torque transmission portion 30 to the other side in the axial direction.

In regard to the axial direction, a direction in which the input shaft body 31 protrudes as viewed from the torque transmission portion 30 is referred to as a first direction X1. The direction in which the output shaft body 21 protrudes as viewed from the inner ring portion 20 is referred to as a second direction X2. In regard to the circumferential direction, description will be given based on a case of being viewed from the second direction X2 as illustrated in FIG. 1. The leftward rotation direction (counterclockwise direction) as viewed from the second direction X2 is referred to as a first rotation direction L1. The rightward rotation direction (clockwise direction) as viewed from the second direction X2 is referred to as a second rotation direction L2.

As illustrated in FIG. 1, an outer peripheral surface 22 of the inner ring portion 20 faces the inner peripheral surface 10 of the fixed part 1. The diameter of the outer peripheral surface 22 is substantially the same as the diameter of the inner peripheral surface 10 of the fixed part 1. The inner ring portion 20 is rotatably disposed on the inner peripheral side of the fixed part 1.

Three recessed surfaces 23 recessed radially inward are formed on the outer peripheral surface 22 of the inner ring portion 20. A pressing portion 34, which will be described later, of the input shaft 3, two (a pair of) first rollers 4, and two (a pair of) second rollers 5 are accommodated inside each recessed surface 23.

As illustrated in FIG. 2, the outer diameter of the torque transmission portion 30 is substantially the same as the diameter of the inner peripheral surface 10 of the fixed part 1. The torque transmission portion 30 is rotatably disposed on the inner peripheral side of the fixed part 1. The torque transmission portion 30 includes a disk-shaped disk portion 33 disposed in the first direction X1 with respect to the inner ring portion 20 and pressing portions 34 protruding from the disk portion 33 in the second direction X2.

As illustrated in FIG. 1, each of the first rollers 4 and the second rollers 5 is a cylindrical roller formed in a columnar shape. The diameter of the first rollers 4 is denoted as H1 (see FIG. 1). The second rollers 5 have a diameter of H2 (see FIG. 1), which is smaller than that of the first rollers 4.

Three virtual lines W1, W2, and W3 illustrated in FIG. 1 are straight lines extending in the radial direction from the central axis X and are arranged at intervals of 120°.

The internal shape of the fixed part 1 is three-rotationally symmetric about the central axis X. That is, when the fixed part 1 is divided into three in the circumferential direction along the virtual lines W1, W2, and W3, any one of the divided shapes is the same as the other shapes. In the following description, one of the three divisions will be described.

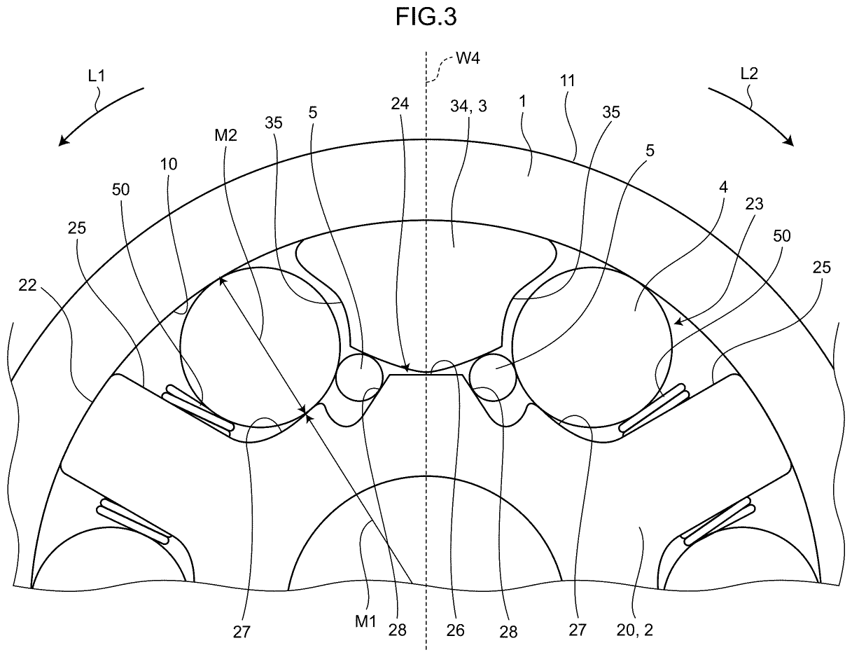

FIG. 3 is an enlarged view of one of the recessed surfaces of FIG. 1. A virtual line W4 in FIG. 3 passes through a center portion of the recessed surface 23 in the circumferential direction from the central axis X. The recessed surface 23 is formed line-symmetrically with respect to the virtual line W4. More specifically, the recessed surface 23 has a bottom surface 24 and a pair of pressed surfaces 25. The bottom surface 24 includes a central surface 26 located at a circumferential central portion of the bottom surface 24, a pair of cam surfaces 27 located at opposite circumferential end portions of the bottom surface 24, and a pair of guide surfaces 28 located between the central surface 26 and the cam surfaces 27. Hereinafter, in the circumferential direction, a direction in which the cam surface 27 is disposed as viewed from the central surface 26 is referred to as a circumferentially outer side. Meanwhile, in the circumferential direction, a direction in which the central surface 26 is disposed as viewed from the cam surface 27 is referred to as a circumferentially inner side.

A first roller 4 is disposed on a radially outer side with respect to the cam surface 27. A radius M1 from the central axis X to the cam surface 27 gradually decreases as the distance from a pressed surface 25 is decreased. Therefore, as the distance from the pressed surface 25 is decreased, a distance M2 between the inner peripheral surface 10 of the fixed part 1 and the cam surface 27 gradually increases.

When the first roller 4 moves toward the guide surface 28, the first roller 4 is wedged between the cam surface 27 and the inner peripheral surface 10, whereby the output shaft 2 enters a locked state. That is, a distance M2 from a portion of the cam surface 27 closer to the guide surface 28 to the inner peripheral surface 10 is smaller than a diameter H1 of the first roller 4 (see FIG. 1).

On the other hand, when the first roller 4 moves toward the pressed surface 25, the first roller 4 is loosely fitted without being wedged between the cam surface 27 and the inner peripheral surface 10 (unlocked state).

That is, a distance M2 from a portion of the cam surface 27 closer to the pressed surface 25 to the inner peripheral surface 10 is larger than the diameter H1 of the first roller 4 (see FIG. 1).

The details of the locked state will be described. When a first roller 4 disposed in the first rotation direction L1 with respect to the pressing portion 34 is wedged, the rotation of the output shaft 2 in the first rotation direction L1 is restricted. On the other hand, when a first roller 4 disposed in the second rotation direction L2 with respect to the pressing portion 34 is wedged, the rotation of the output shaft 2 in the second rotation direction L2 is restricted.

As illustrated in FIG. 3, the central surface 26 is formed in a linear shape orthogonal to the virtual line W4. In the present disclosure, the central surface 26 may not be linear but may be formed in an arc shape around the central axis X.

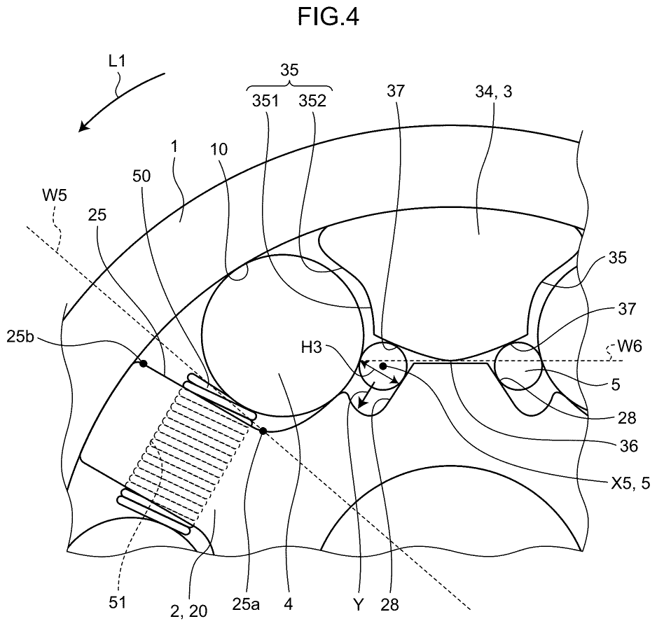

FIG. 4 is an enlarged view in which a part of FIG. 3 is enlarged. A second roller 5 is disposed radially outside the guide surface 28, and the second roller 5 is in contact with the guide surface 28. The guide surface 28 is located radially inward as it extends circumferentially outward. Therefore, when the second roller 5 moves circumferentially outward along the guide surface 28, the amount of inward travel in the radial direction increases.

Meanwhile, the shortest distance (see FIG. 4) between the first roller 4 and the guide surface 28 in the locked state is denoted as H3. The shortest distance H3 is smaller than the diameter H2 (see FIG. 1) of the second roller 5. The center X5 of the second roller 5 is disposed radially outward with respect to the line indicating the shortest distance H3. When the first roller 4 moves circumferentially outward, the shortest distance H3 moves radially inward (circumferentially outward) as indicated by an arrow Y in FIG. 4. That is, the second roller 5 can move radially inward (circumferentially outward).

The pressed surface 25 is a surface with which the first roller 4 comes into contact. The pressed surface 25 is linear from a radially inner end 25a toward a radially outer end 25b of the pressed surface 25. The outer end 25b is disposed circumferentially outward with respect to a virtual line W5 drawn from the central axis X to the inner end 25a. That is, the pressed surface 25 is inclined circumferentially outward.

A coil spring 50 which is an elastic body is provided between the pressed surface 25 and the first roller 4. The coil spring 50 is disposed in a compressed state relative to the natural length. The first roller 4 is constantly biased circumferentially inward by the coil spring 50. Therefore, even with no external force input to the output shaft 2, the first roller 4 is wedged between the inner peripheral surface 10 and the cam surface 27 (locked state).

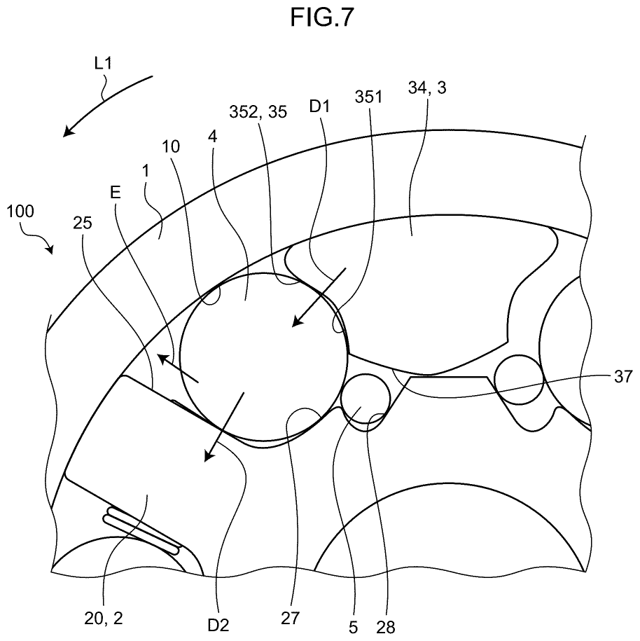

A hole 51 is formed in the pressed surface 25. A part of the coil spring 50 is accommodated in the hole 51. When the first roller 4 moves circumferentially outward, the coil spring 50 is accommodated in the hole 51, and the first roller 4 comes into contact with the pressed surface 25 (see FIG. 7). As illustrated in FIG. 1, the hole 51 penetrates a pressed surface 25 of another recessed surface 23 on the back side of the pressed surface 25. That is, the hole 51 communicates the insides of the recessed surfaces 23 adjacent to each other in the circumferential direction. One coil spring 50 biases two first rollers 4.

As illustrated in FIG. 4, the pressing portion 34 has a pair of side surfaces 35 facing circumferentially outward, an inner surface 36 facing radially inward, and a pair of second rolling element pressing surfaces 37 formed at corner portions where the side surfaces 35 and the inner surface 36 intersect.

A side surface 35 has an inner side surface 351 disposed radially inward and an outer side surface 352 disposed radially outward with respect to a radially central portion of the side surface 35. The outer side surface 352 is disposed circumferentially outward as it extends radially outward and protrudes circumferentially outward from the inner side surface 351.

A virtual line W6 illustrated in FIG. 4 is a straight line orthogonal to the virtual line W4 (see FIG. 3). The inner surface 36 extends along the virtual line W6. The second rolling element pressing surfaces 37 are formed linearly. In a state where the pressing portion 34 is disposed at the center portion in the circumferential direction, the second rolling element pressing surfaces 37 are in contact with second rollers 5. When the pressing portion 34 moves circumferentially outward, a second rolling element pressing surface 37 presses a second roller 5. The pressed second roller 5 is pushed between the first roller 4 and the guide surface 28.

The second rolling element pressing surface 37 is oriented in such a direction that the pressed second roller 5 moves between the first roller 4 and the guide surface 28. The second rolling element pressing surface 37 of the present embodiment is disposed so as to be gradually located radially outward as it extends circumferentially outward and is inclined so as to cross the virtual line W6.

Next, the operation of the power transmission device of the first embodiment will be described. First, the initial state of the power transmission device 100 (a state in which no torque nor external force are input) will be described.

As illustrated in FIG. 3, a pair of first rollers 4 is pressed by coil springs 50 and moved circumferentially inward. The first roller 4 is sandwiched between the inner peripheral surface 10 and the cam surface 27. That is, the output shaft 2 is in the locked state in the initial state.

In the initial state, the side surfaces 35 of the pressing portion 34 are not in contact with the first rollers 4. The second rolling element pressing surfaces 37 of the pressing portion 34 are in contact with the second rollers 5. The second roller 5 is in contact with each of the first roller 4 and the guide surface 28.

Next, a case where torque is input to the input shaft body 31 (see FIG. 2) of the power transmission device 100 in the initial state will be described. In the following description, a state in which no external force acts on the output shaft 2 will be first described. The same operation is obtained in cases where the direction of the input torque is in the first rotation direction L1 and in the second rotation direction L2. Therefore, the case where the direction of the torque is the first rotation direction L1 will be described below.

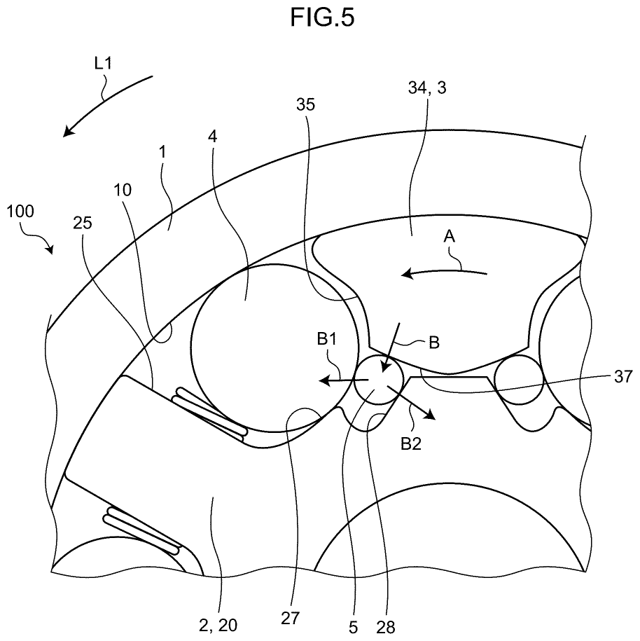

FIG. 5 is a diagram illustrating an operation state of the power transmission device of the first embodiment and, specifically, is a diagram as of the start of input of torque. As illustrated in FIG. 5, when torque in the first rotation direction L1 is input to the input shaft body 31 (see FIG. 2), a load A in the first rotation direction L1 is transmitted to the pressing portion 34. The side surface 35 of the pressing portion 34 in the initial state is not in contact with the first roller 4. Therefore, at the start of torque input, the pressing portion 34 does not press the first roller 4.

On the other hand, the pressing portion 34 is in contact with the second roller 5. Therefore, the pressing portion 34 presses the second roller 5 by the second rolling element pressing surface 37, and the second roller 5 receives a load B from the pressing portion 34. As a result, the second roller 5 is pushed into between the first roller 4 and the guide surface 28. Then, such loads B1 and B2 that are separate from each other act on the first roller 4 and the guide surface 28. When the load B1 acting on the first roller 4 is decomposed, a component in the first rotation direction L1 is included in addition to a radially outward component.

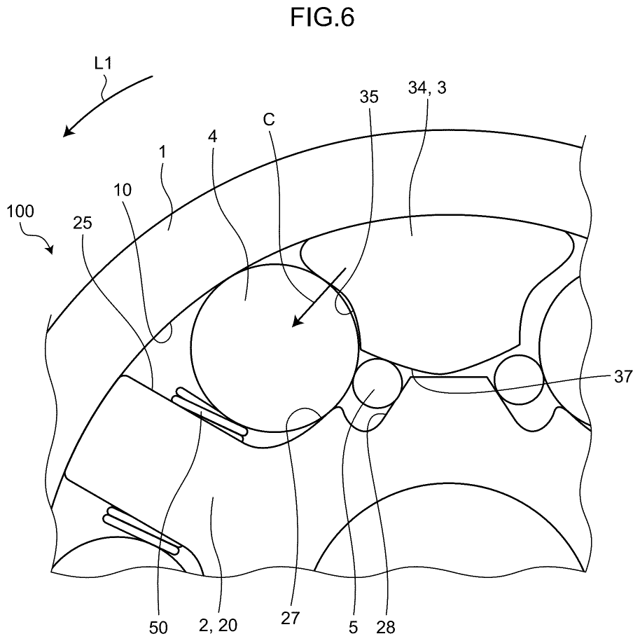

FIG. 6 is a diagram illustrating an operation state of the power transmission device of the first embodiment and is, specifically, a diagram as of the time when a locked state is released. Therefore, as illustrated in FIG. 6, the first roller 4 moves in the first rotation direction L1, whereby the state (locked state) of being wedged between the inner peripheral surface 10 and the cam surface 27 is released.

Meanwhile, the load B2 (see FIG. 5) acting on the guide surface 28 includes a component in the second rotation direction L2, and torque in the second rotation direction L2 acts on the output shaft 2. This torque is such a load that moves the cam surface 27 in the second rotation direction L2 with respect to the first roller 4. From the above, the load B2 includes the torque for unlocking, and the torque required for unlocking is reduced.

When the locked state is released, the pressing portion 34 starts to move in the first rotation direction L1. The second roller 5 starts to move radially inward along the guide surface 28. At this point, when the second roller 5 moves radially inward, the distance between the first roller 4 and the pressing portion 34 decreases, and as illustrated in FIG. 6, the side surface 35 of the pressing portion 34 comes into contact with the first roller 4. Therefore, after the locked state is released, the first roller 4 receives a load C from the pressing portion 34 and moves in the first rotation direction L1 while compressing the coil spring 50. Even after the locked state is released, the first roller 4 receives the load B1 (see FIG. 5) from the second roller 5 for a while. FIG. 7 is a diagram illustrating an operation state of the power transmission device of the first embodiment and is, specifically, a diagram in a state where a first roller is in contact with a pressed surface. As illustrated in FIG. 7, when the first roller 4 moves in the first rotation direction L1 to some extent, the first roller 4 comes into contact with the pressed surface 25. After the contact with the first roller 4, the pressing portion 34 presses the pressed surface 25 via the first roller 4 (see arrows D1 and D2 in FIG. 7). As a result, the torque in the first rotation direction L1 is transmitted to the output shaft 2, and the output shaft 2 rotates in the first rotation direction L1.

Incidentally, when the pressing portion 34 is pressing the pressed surface 25 via the first roller 4, the portion of the side surface 35 that is in contact with the first roller 4 is not the inner side surface 351 but the outer side surface 352. The outer side surface 352 is formed so as to be substantially parallel to the pressed surface 25. Therefore, a load D1 acting on the first roller 4 from the outer side surface 352 is a normal vector of the pressed surface 25. Therefore, the amount of the loss of torque transmitted from the pressing portion 34 to the output shaft 2 is extremely small, and the torque is efficiently transmitted.

Since the pressed surface 25 is inclined, the first roller 4 is pressed against the pressed surface 25 and moves radially outward (see an arrow E in FIG. 7). Therefore, the clearance between the inner peripheral surface 10 of the fixed part 1 and the first roller 4 is small.

As illustrated in FIG. 7, when the amount of radially inward travel of the second roller 5 increases, the second roller 5 is separated from the second rolling element pressing surface 37. Therefore, when the pressing portion 34 is pressing the pressed surface 25 via the first roller 4, the second roller 5 receives no load from the pressing portion 34.

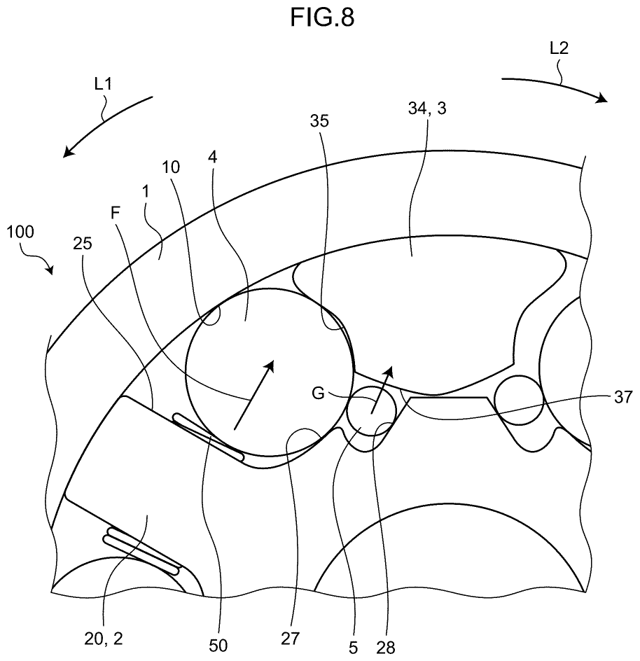

FIG. 8 is a diagram illustrating an operation state of the power transmission device of the first embodiment and is, specifically, a diagram as of the time when the first roller starts to return in the second rotation direction.

As illustrated in FIG. 8, when the input of torque to the input shaft body 31 is released, the first roller 4 is pressed by the coil spring 50 and moves in the second rotation direction L2 (see an arrow F in FIG. 8). When the first roller 4 moves in the second rotation direction L2 to some extent, as illustrated in FIG. 3, the first roller 4 is wedged between the cam surface 27 and the inner peripheral surface 10 (locked state).

Meanwhile, an oil film having a constant thickness is formed on the inner peripheral surface 10 of the fixed part 1. That is, the oil film is also interposed between the inner peripheral surface 10 of the fixed part 1 and the first roller 4. In order to lock the output shaft 2, the first roller 4 needs to shear the oil film. If the thickness of the oil film between the inner peripheral surface 10 and the first roller 4 is large, there is a possibility that the first roller 4 cannot easily shear the oil film and thus the output shaft 2 is not locked.

As illustrated in FIG. 7, when the first roller 4 is pressed against the pressed surface 25, the clearance between the inner peripheral surface 10 and the first roller 4 decreases. That is, the thickness of the oil film interposed between the inner peripheral surface 10 and the first roller 4 decreases. Therefore, according to the present embodiment, the first roller 4 easily shears the oil film interposed between the first roller 4 and the inner peripheral surface 10, whereby the output shaft 2 is reliably locked.

When the first roller 4 moves in the second rotation direction L2, the second roller 5 in contact with the first roller 4 receives a load in the second rotation direction L2. The second roller 5 is lifted radially outward along the guide surface 28 (see an arrow G in FIG. 8). As a result, the second roller 5 comes into contact with the second rolling element pressing surface 37 of the pressing portion 34 (see FIG. 3).

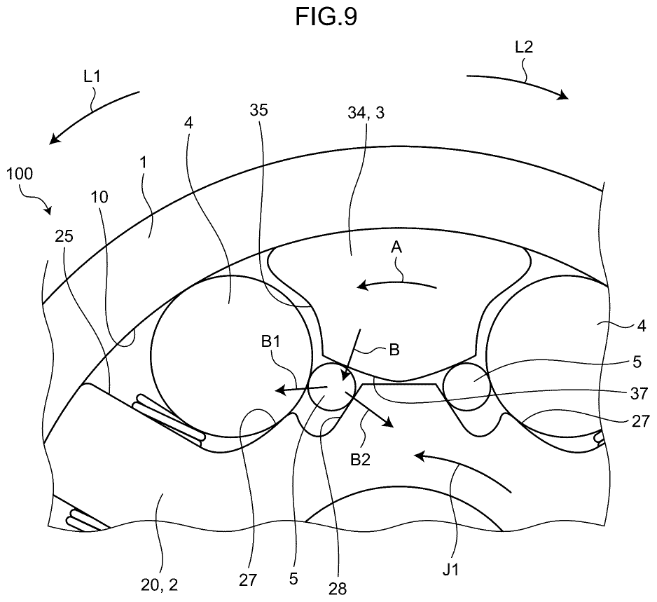

FIG. 9 is a diagram as of the time when input of torque to the input shaft (first rotation direction) is started in a state where an external force (first rotation direction) is acting on the output shaft in the power transmission device of the first embodiment. The following describes a case where an external force in the same direction (first rotation direction L1) acts on the output shaft 2 at the time point when the input of the torque to the input shaft 3 is started. The cause of the jerking phenomenon is that, when the locked state is released after the first rollers 4 move in the first rotation direction L1, the output shaft 2 also rotates in the first rotation direction L1 due to an external force (see an arrow J1 in FIG. 9), and then the first rollers 4 are again wedged between the inner peripheral surface 10 and the cam surfaces 27.

As illustrated in FIG. 9, when the pressing portion 34 pushes the second roller 5 between the first roller 4 and the guide surface 28 at the start of torque input to the input shaft 3, a load B2 acts on the guide surface 28. The load B2 includes a component in the second rotation direction L2. Therefore, the output shaft 2 is prevented from rotating in the first rotation direction L1. That is, the first rollers 4 are prevented from being wedged again between the inner peripheral surface 10 and the cam surfaces 27, whereby occurrence of the jerking phenomenon is avoided.

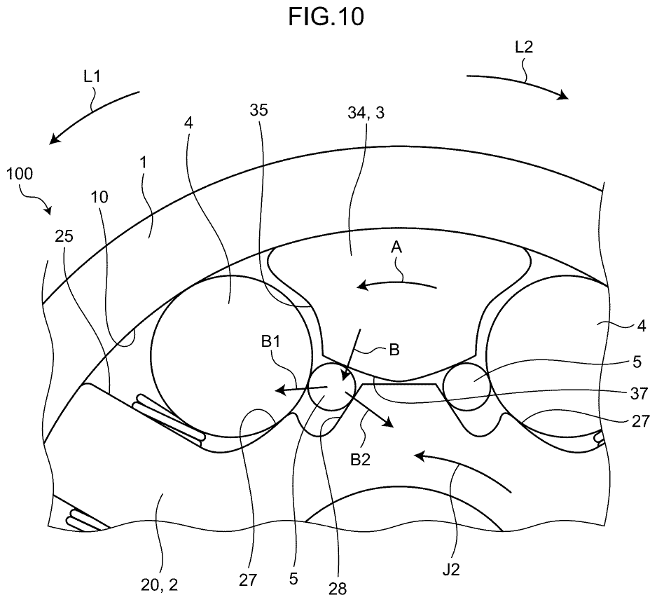

FIG. 10 is a diagram as of the time when input of torque to the input shaft (first rotation direction) is started in a state where an external force (second rotation direction) is acting on the output shaft in the power transmission device of the first embodiment. On the other hand, as illustrated in FIG. 10, when input of torque (first rotation direction L1) to the input shaft 3 is started in a state where an external force in the opposite direction (second rotation direction L2) is acting on the output shaft 2, the pressing portion 34 presses the first roller 4 via the second roller 5 (see arrows B and B1). Then, the first roller 4 moves to press the pressed surface 25 in the first rotation direction L1. As a result, the output shaft 2 rotates in the first rotation direction L1 (see arrow J2). As a result, the first rollers 4 are not sandwiched between the inner peripheral surface 10 and the cam surfaces 27, whereby the jerking phenomenon does not occur.

Although the power transmission device 100 of the first embodiment has been described above, the present disclosure is not limited to the example described in the first embodiment. For example, in the first embodiment, an example is described in which cylindrical rollers are used as the rolling elements; however, the present disclosure may be implemented with balls. The following describes a modification in which a part of the power transmission device 100 of the first embodiment is modified. In the following description, only differences from the power transmission device 100 described above will be described.

### First Modification

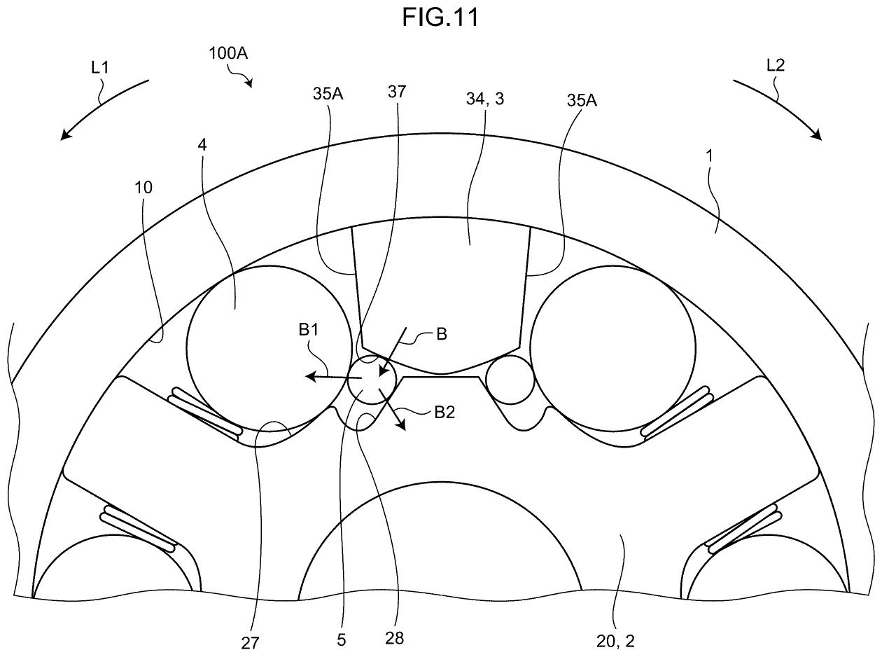

FIG. 11 is an enlarged view in which one of recessed surfaces of a power transmission device of a first modification is enlarged. A power transmission device 100A of the first modification is different from that of the first embodiment in that the entire side surface 35A of the pressing portion 34 is flat. That is, the outer side surface 352 protruding circumferentially outward from the inner side surface 351 is not formed on the side surface 35A of the first modification.

Even in the power transmission device 100A of the first modification, the pressing portion 34 presses the second roller 5 at the start of input of torque to the input shaft 3 (see an arrow B). Then, such loads B1 and B2, which are separate from each other, act on the first roller 4 and the guide surface 28. Therefore, even if an external force in the same direction as the torque input to the input shaft 3 acts on an output shaft 2, the rotation of the output shaft 2 in the first rotation direction L1 is suppressed. From the above, in the power transmission device 100A of the first modification, similarly to the first embodiment, first rollers 4 are inhibited from being wedged again between the inner peripheral surface 10 and cam surfaces 27, and occurrence of the jerking phenomenon is avoided. Furthermore, according to the first modification, similarly to the first embodiment, the torque required for unlocking can be reduced.

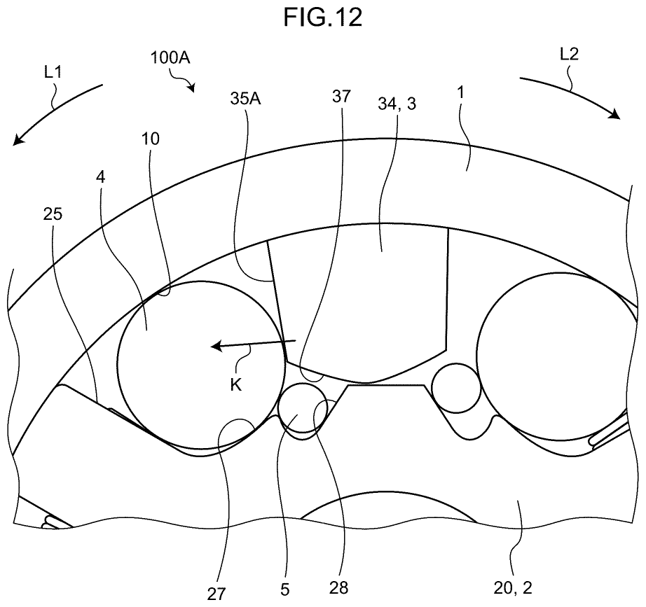

FIG. 12 is a diagram illustrating a state in which a pressing portion is pressing a pressed surface via a first roller in the power transmission device of the first modification. According to the power transmission device 100A of the first modification, the side surface 35A of the pressing portion 34 that presses the pressed surface via the first roller 4 is not parallel to the pressed surface 25. That is, a load K acting on the first roller 4 from the side surface 35A is not a normal vector of the pressed surface 25. Therefore, as compared with the first embodiment, the amount of the loss of torque transmitted from the pressing portion 34 to the output shaft 2 is large.

### Second Modification

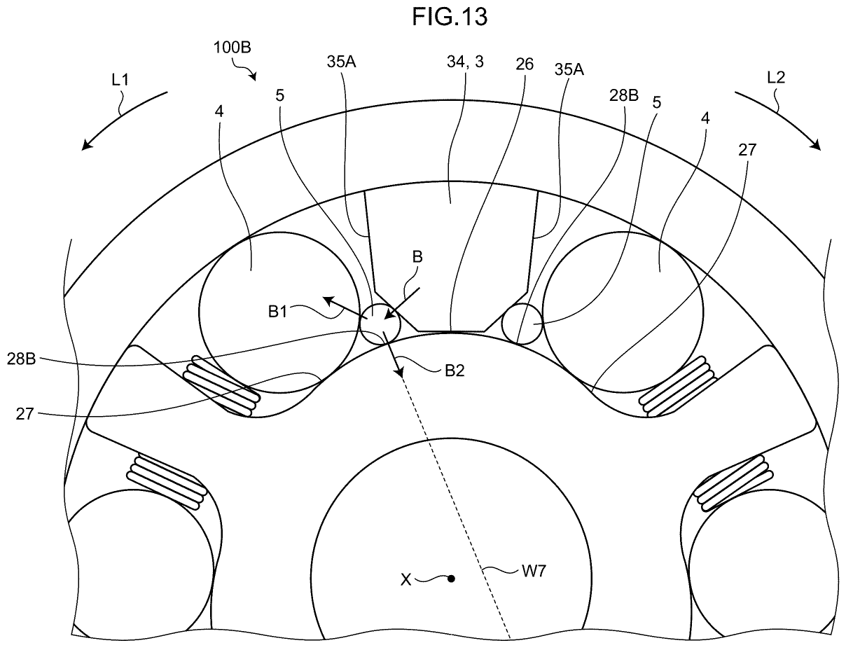

FIG. 13 is an enlarged view in which one of recessed surfaces of a power transmission device of a second modification is enlarged. As illustrated in FIG. 13, a power transmission device 100B of the second modification is different from the first modification in that the shape of a guide surface 28B is different. The guide surface 28B of the second modification is formed in an arc shape centered on the central axis X. A virtual line W7 is an extension line of a load B2 acting on the guide surface 28B. Also in this second modification, the load B2 acting on the guide surface 28B includes a component in the second rotation direction L2, and rotation in the first rotation direction L1 by an output shaft 2 is suppressed. That is, even in the second modification, the jerking phenomenon hardly occurs. Furthermore, according to the second modification, similarly to the first embodiment, the torque required for unlocking can be reduced.

Comparing the load B2 of the second modification (see FIG. 13) with the load B2 of the first embodiment (see FIG. 5), the load B2 of the first embodiment is oriented in the circumferential direction. That is, the torque in the second rotation direction L2 acting on the output shaft 2 is larger in the first embodiment than in the second modification. Therefore, the first embodiment is more preferable since the jerking phenomenon is less likely to occur and the torque required for unlocking can be reduced.

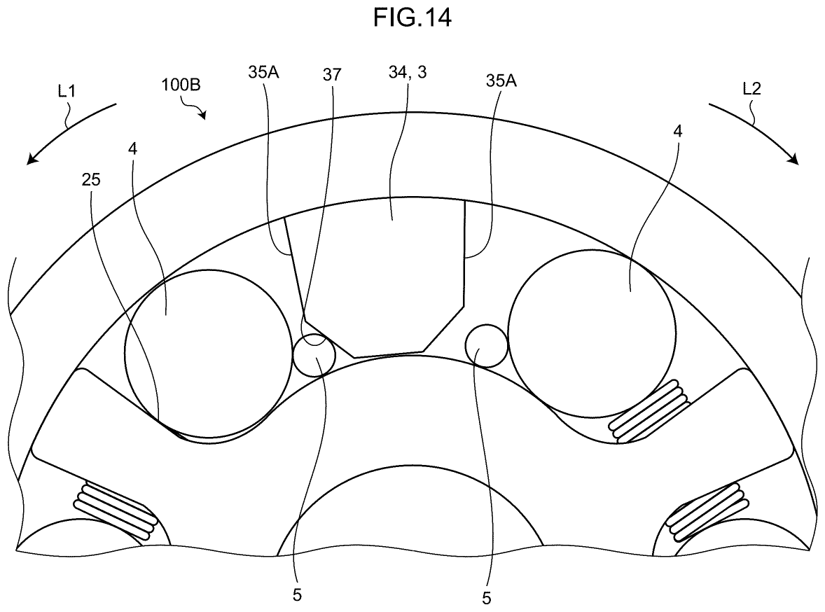

FIG. 14 is a diagram illustrating a state in which a pressing portion is pressing a pressed surface via a second roller and a first roller in the power transmission device of the second modification. According to the guide surface 28B of second modification, the second roller 5 pressed by the second rolling element pressing surface 37 does not travel radially inward (does not move) even when moving circumferentially outward. That is, since the distance between the pressing portion 34 and the first roller 4 does not decrease, the side surface 35A does not come into contact with the first roller 4. Therefore, as illustrated in FIG. 14, the pressing portion 34 presses the first roller 4 via the second roller 5, whereby torque is transmitted to the output shaft 2.

### Third Modification and Fourth Modification

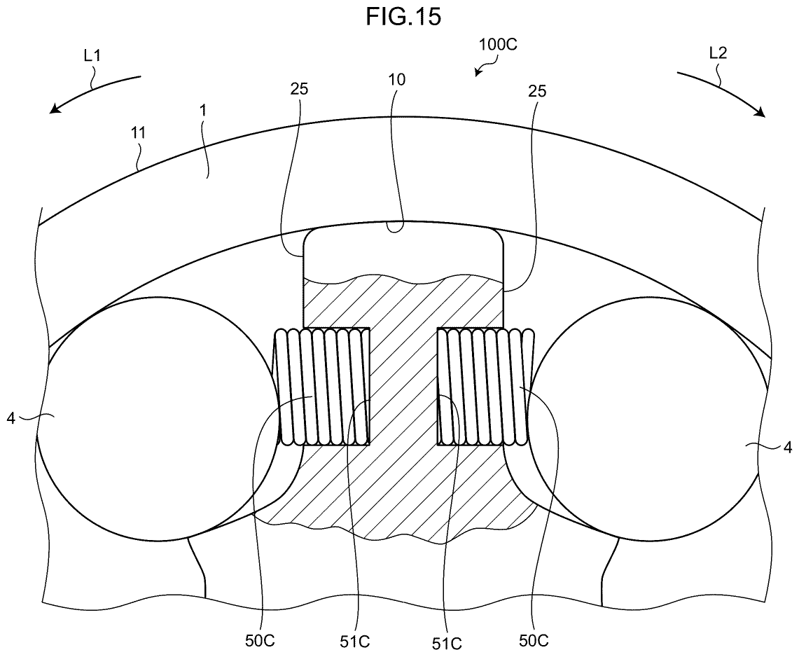

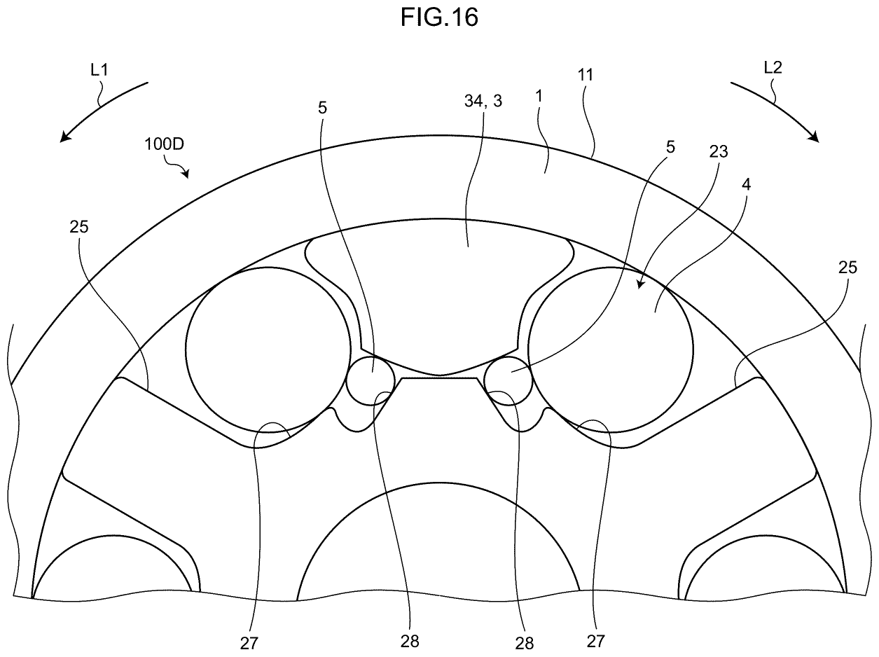

FIG. 15 is a partial cross-sectional view in which the vicinity of a pressed surface is enlarged in a power transmission device of a third modification. FIG. 16 is an enlarged view in which one of recessed surfaces of a power transmission device of a fourth modification is enlarged. As illustrated in FIG. 15, a power transmission device 100C of the third modification is different from the first embodiment in that a hole 51C does not penetrate. As illustrated in FIG. 16, a power transmission device 100D of the fourth modification is different from the first embodiment in that the coil springs 50 are not included. Even in the third modification and the fourth modification as described above, occurrence of the jerking phenomenon is avoided similarly to the first embodiment and the like.

The modifications have been described above. In addition, three recessed surfaces 23 are formed on the output shaft 2 of the first embodiment; however, the number of recessed surfaces 23 is not particularly limited in the present disclosure. Although the pressing portions 34 and the first rollers 4 are separated from each other in the initial state in the first embodiment, the pressing portions 34 may abut on the first rollers 4 in the present disclosure. According to this, the first rollers 4 receive the load B1 (see FIG. 5 and others) applied from the second rollers 5 and also receive a load from the pressing portions 34 to move circumferentially outward, whereby the locked state is released.

Next, a driving unit 5000 including the power transmission device 100 according to the first embodiment will be described.

### Second Embodiment

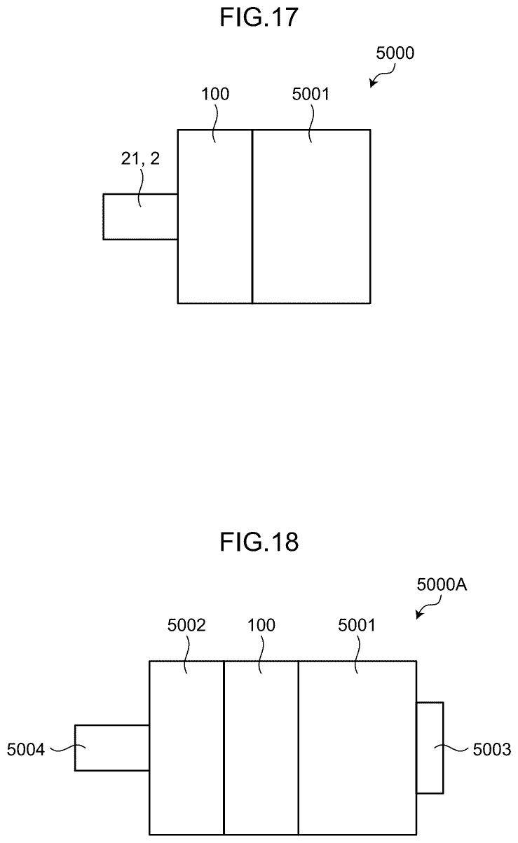

FIG. 17 is a schematic diagram illustrating the configuration of a driving unit of a second embodiment. As illustrated in FIG. 17, the driving unit 5000 includes a motor 5001 and the power transmission device 100 described above. The motor 5001 is a device for generating torque. An output shaft (not illustrated) of the motor 5001 is connected to the input shaft body 31 (not illustrated in FIG. 17, see FIG. 2) of the power transmission device 100.

Such a driving unit 5000 is used for, for example, an electric slider, a robot arm, an elevating device, a transport robot, an electric cart, an electric assist bicycle, electric mobility, a carriage, a stroller, or the like. In other words, an electric slider or the like is connected to the output shaft body 21 of the power transmission device 100. When the motor 5001 of the driving unit 500 is driven, torque is transmitted to the electric slider or the like via the power transmission device 100.

Meanwhile, even if an external force acts on the electric slider or the like, and the external force is transmitted to the output shaft 2, the output shaft 2 does not rotate. Therefore, the electric slider connected to the output shaft 2 is not rotated, moved, or changed in attitude by the external force. Therefore, according to the driving unit 5000, no electromagnetic brake that restricts rotation and the like due to an external force is necessary, which makes it possible to reduce the power to be used.

The second embodiment has been described above. Although the driving unit 5000 of the second embodiment includes the power transmission device 100 described in the first embodiment, the configuration in the present disclosure may include the power transmission devices described in the first to fourth modifications.

FIG. 18 is a schematic diagram illustrating the configuration of a driving unit of a fifth modification. Although the driving unit 5000 of the second embodiment includes the motor 5001 and the power transmission device 100, the driving unit in the present disclosure may be a driving unit 5000A of the fifth modification including the motor 5001, the power transmission device 100, a speed reducer 5002, and a sensor 5003 that detects the rotation angle or the like of an output shaft of the motor 5001 as illustrated in FIG. 18. The speed reducer 5002 is a device for increasing torque. In the fifth modification, an electric slider or the like is connected to an output shaft 5004 of the speed reducer 5002.

Note that the present disclosure may include combinations of the following configurations. (1) A power transmission device comprising:
an annular fixed part including an inner peripheral surface;
an output shaft including an outer peripheral surface facing the inner peripheral surface and a recessed surface recessed radially inward from the outer peripheral surface;
an input shaft including a pressing portion accommodated in the recessed surface;
a pair of first rolling elements that are accommodated in the recessed surface and are arranged on opposite sides in a circumferential direction with respect to the pressing portion; and
a pair of second rolling elements each of which has a smaller diameter than a diameter of each first rolling element and is arranged between the corresponding first rolling element and the pressing portion, wherein
the recessed surface includes:
   a bottom surface extending in the circumferential direction and facing the inner peripheral surface in a radial direction; and
   a pair of pressed surfaces extending radially outward from opposite circumferential ends of the bottom surface,
the bottom surface includes:
   a pair of cam surfaces each having the corresponding first rolling element arranged on a radially outer side; and
   a pair of guide surfaces each having the corresponding second rolling element arranged on a radially outer side,
a distance between each cam surface and the inner peripheral surface gradually increases with proximity to the corresponding pressed surface,
a distance between a portion of each cam surface closer to the corresponding guide surface and the inner peripheral surface is smaller than a diameter of each first rolling element,
a distance between a portion of each cam surface closer to the corresponding pressed surface and the inner peripheral surface is larger than the diameter of each first rolling element,
the second rolling element is sandwiched between the first rolling element, the guide surface, and the pressing portion, and
the pressing portion pushes the second rolling element between the first rolling element and the guide surface when the pressing portion moves circumferentially outward from a state in which the pressing portion is disposed at a center portion of the recessed surface in the circumferential direction.

(2) The power transmission device according to (1), wherein
the guide surface is disposed radially inward with proximity to the cam surface.

(3) The power transmission device according to (2), wherein
the pressing portion includes side surfaces each facing circumferentially outward, and
when at least a part of each side surface is pressing the corresponding pressed surface via the corresponding first rolling element, the part of the side surface is parallel to the corresponding pressed surface.

(4) The power transmission device according to (1), wherein
each of the guide surfaces is formed in an arc shape around a central axis of the inner peripheral surface.

(5) The power transmission device according to any one of (1) to (4), wherein
each of the pressed surfaces is inclined circumferentially outward with an outer end in a radial direction of the pressed surface disposed outside in a circumferential direction with respect to a virtual line extending from a central axis of the inner peripheral surface to an inner end in the radial direction of the pressed surface.

(6) The power transmission device according to any one of (1) to (5), further comprising:
elastic bodies each of which is disposed between the pressed surface and the corresponding first rolling element and biases the corresponding first rolling element toward the pressing portion.

According to the power transmission device of the present disclosure, the occurrence of the jerking phenomenon is suppressed, and the torque required for unlocking is also reduced.

What is claimed is:

1. A power transmission device comprising:
an annular fixed part including an inner peripheral surface;
an output shaft including an outer peripheral surface facing the inner peripheral surface and a recessed surface recessed radially inward from the outer peripheral surface;
an input shaft including a pressing portion accommodated in the recessed surface;
a pair of first rolling elements that are accommodated in the recessed surface and are arranged on opposite sides in a circumferential direction with respect to the pressing portion; and
a pair of second rolling elements each of which has a smaller diameter than a diameter of each first rolling element and is arranged between the corresponding first rolling element and the pressing portion, wherein
the recessed surface includes:
a bottom surface extending in the circumferential direction and facing the inner peripheral surface in a radial direction; and
a pair of pressed surfaces extending radially outward from opposite circumferential ends of the bottom surface,
the bottom surface includes:
a pair of cam surfaces each having the corresponding first rolling element arranged on a radially outer side; and
a pair of guide surfaces each having the corresponding second rolling element arranged on a radially outer side,
a distance between each cam surface and the inner peripheral surface gradually increases with proximity to the corresponding pressed surface,
a distance between a portion of each cam surface closer to the corresponding guide surface and the inner peripheral surface is smaller than a diameter of each first rolling element,
a distance between a portion of each cam surface closer to the corresponding pressed surface and the inner peripheral surface is larger than the diameter of each first rolling element,
the second rolling element is sandwiched between the first rolling element, the guide surface, and the pressing portion, and
the pressing portion pushes the second rolling element between the first rolling element and the guide surface when the pressing portion moves circumferentially outward from a state in which the pressing portion is disposed at a center portion of the recessed surface in the circumferential direction.

2. The power transmission device according to claim 1, wherein
the guide surface is disposed radially inward with proximity to the cam surface.

3. The power transmission device according to claim 2, wherein
the pressing portion includes side surfaces each facing circumferentially outward, and
when at least a part of each side surface is pressing the corresponding pressed surface via the corresponding first rolling element, the part of the side surface is parallel to the corresponding pressed surface.

4. The power transmission device according to claim 1, wherein
each of the guide surfaces is formed in an arc shape around a central axis of the inner peripheral surface.

5. The power transmission device according to claim 1, wherein
each of the pressed surfaces is inclined circumferentially outward with an outer end in a radial direction of the pressed surface disposed outside in a circumferential direction with respect to a virtual line extending from a central axis of the inner peripheral surface to an inner end in the radial direction of the pressed surface.

6. The power transmission device according to claim 1, further comprising:
elastic bodies each of which is disposed between the pressed surface and the corresponding first rolling element and biases the corresponding first rolling element toward the pressing portion.
